(19) United States
(12) Patent Application Publication
(10) Pub. No.: US 2012/0124017 A1
(43) Pub. Date: May 17, 2012

(54) COMPRESSION METHOD, DECOMPRESSION METHOD, COMPRESSION UNIT, DECOMPRESSION UNIT AND COMPRESSED DOCUMENT

(75) Inventors: Jörg Heuer, Oberhaching (DE); Thomas Kurz, Bischofswiesen (DE); Daniel Peintner, Meransen Muehlbach (IT)

(73) Assignee: SIEMENS AKTIENGESELLSCHAFT, München (DE)

(21) Appl. No.: 13/262,590

(22) PCT Filed: Mar. 22, 2010
(86) PCT No.: PCT/EP2010/053662

§ 371 Date: Feb. 2, 2012

(30) Foreign Application Priority Data
Mar. 31, 2009 (DE) 10 2009 015 734.4

(51) Int. Cl. G06F 17/30

(52) U.S. Cl. 707/693; 707/E17.008

(57) ABSTRACT

A structured document having at least one informational unit with at least one character is divided, according to a first base type, into sections of a second base type. The sections are compressed according to specified compression instructions for the second base type to achieve an increased rate of compression. The informational elements may be expressed in an XML language. The compression method and corresponding compression unit, decompression method and decompression unit can be applied in the area of initialization of end devices, such as in systems engineering or in the IT consumer industry.

### CROSS REFERENCE TO RELATED APPLICATIONS

This application is based on and hereby claims priority to International Application No. PCT/EP2010/053662 filed on Mar. 22, 2010 and German Application No. 10 2009 015 734.4 filed on Mar. 31, 2009. The contents of both of which are hereby incorporated by reference.

### BACKGROUND

Described below are the compression and decompression of structured documents, in particular a compression method, a decompression method, a compression unit and a decompression unit and a compressed document for example in binary form.

Information has been represented with the aid of structured documents for many years. One very well known standard for the representation of structured documents is XML (XML eXtensible Markup Language) from W3C (W3C—World Wide Web Consortium). This is used to provide information in numerous applications and devices. For example, it is possible to provide configuration data for the initialization of end devices, such as, for example, mobile telephones or system groups with structured documents. A further example is the use of structured documents to describe multimedia content, such as is used for example in the SVG standard (SVG—Scalable Vector Graphics).

Structured documents have the drawback that a large data volume is required for storage or transmission. For this reason, compression methods were developed to reduce the data volume of structured documents. Examples to mention are GZIP (GZIP—GNU ZIP), a BIM standard BIM (BIM—Binary MPEG format for XML) from MPEG (MPEG—Motion Picture Expert Group) or EXI (Efficient XML Interchange) from W3C, which generate a compressed document in binary form. Nevertheless, there is still a requirement further to reduce the data volume, since in particular small and very inexpensive end devices, such as, for example, sensors, which communicate via a mesh network, only have a small memory.

### SUMMARY

Therefore, described below are a compression method and a compression unit that further reduce a data volume during the compression of a structured document. In addition, an associated decompression method and a decompression unit are described.

According to the described compression method for compression of a structured document, the structured document includes at least one informational unit, which is instantiated by a type of a specified structural instruction, where the structural instruction includes a first base type and a second base type. The first base type is used to represent at least one character, the type includes a data field, which is represented by the at least one first base type and a structure of the data field is determined by a regular expression. A specified compression method can compress the structured document into a compressed document, in which the following operations are performed:
determination of at least one part of the regular expression in such a way that this respective part may be represented by the second base type;
determination of a respective section of the at least one informational unit, which is based on the respective part of the regular expression;
compression of the respective section using the specified compression method in such a way that the specified compression method compresses the respective section on the basis of a specified compression instruction for the second base type.

The inventors have recognized that a compression of data, which are represented by the first base type string results in a poor compression rate. This is based on the discovery that, due to a plurality of characters that it is able to represent, the first base type only achieves a poor compression rate. The informational element, which is generated by the instantiation of a type based on the first base type, includes a character string in the data field defined by the first base type. The compression rate can be improved by dividing the character string into at least one section, which can be compressed by a second base type different from the first base type. In the present method, the structure of the data field is based on a regular expression, for example in BNF (BNF—Backus-Naur Form), wherein analysis of the regular expression enables at least one part of this regular expression to be assigned to one or more non-first base types. Here, it is of advantage that the regular expression explicitly specifies the structure and the possible contents of the data field or of the at least one section so that the at least one part may be assigned to one of the non-first base types without running the risk that possible contents of the section cannot be represented by the selected second base type. A further advantage of the compression method is justified by the fact that the specified decompression method can be used to decompress the structured document since the compression of the sections is exclusively performed on specified base types of the structural instruction using the specified compression method. It should be noted that the first and the second base type are different base types. In addition, the specified compression method can take the structural instruction into account when performing the compression.

In a further development of the compression method, two parts of the regular section and two sections of the at least one informational unit are determined, wherein the two sections are based on the respective part of the regular expression, the two sections are combined to form a new section and the new section is compressed using the specified compression method on the basis of the specified compression instruction for the second base type. This achieves a further increase of the compression rate by combining two or more sections to form a new section.

In addition, for each of the parts, it is possible to form a new type on the basis of the base types, instead of the at least one informational unit, a first number of new informational units is formed, wherein this first number corresponds to a second number of parts and the new informational units are instantiated on the basis of the new types corresponding to the respective parts and occupied by the sections corresponding to the parts. With this additional configuration, each of the parts of the regular expression is assigned its own type based on specified base types of the structural instruction. This makes possible to order the contents, such as for example, with a date, the day, the month or the year. This enables the compression rate to be further increased since, due to the ordering of the contents, a value range of a respective part and hence of an associated section is known. For example, the ordering of the contents of the section relating to the day of the date makes it clear that this value range can only contain the natural numbers 1 to 31. On the basis of this knowledge, when assigning base types, the base type to choose is the one that both includes the entire value range and achieves the highest compression rate for the value range to be covered.

In addition, (before its compression) at least one of the sections can be provided with a tag identifying the section to be compressed. The result of this further development can be that, due to the insertion of a tag for the section to be compressed into the compressed document, the identification of the contents of the compressed sections is made easier. This is accompanied by the increase in the compression rate because the division into several sections causes the compression rate to be increased and also the legibility of the respective section to be improved by the insertion of the tag.

In addition, the tag can be formed on the basis of the part of the regular section on which the respective section is based. The formation of the tag can advantageously be performed by evaluating the parts of the regular expression. For example, the regular expression includes a so-called “tag” such as day, month or year, which can be adopted directly as a tag. This procedure represents a simplification for the creation of the tag.

For example, the structural instruction may be defined by the standard XML, wherein
the at least one informational unit is an XML element or XML attribute,
the structured document is an XML document,
the base types are formed from a quantity of XML type built-in primitive types and built-in derived types.

The present method can also be used when using an XML-based structured document. The XML standard is very widely used so that in particular here, there is a great economic benefit in using the method described below.

The compression unit described below is used for the compression of a structured document, wherein the structured document includes at least one informational unit which is instantiated by a type of a specified structural instruction. The structural instruction includes a first base type and a second base type, the first base type is used to represent at least one character, the type includes a data field, which is represented by the at least one first base type and a structure of the data field is determined by a regular expression. A specified compression method can compress the structured document into a compressed document, in which the compression unit includes the following units:
a first unit for the determination of at least one part of the regular expression in such a way that this respective part may be represented by the second base type
a second unit for the determination of a respective section of the at least one informational unit, which is based on the respective part of the regular expression
a third unit for the compression of the respective section using the specified compression method in such a way that the specified compression method can be used to compress the respective section on the basis of a specified compression instruction for the second base type.

The compression unit has the same advantages as the compression method.

The compression unit also includes a fourth unit embodied in such a way to execute the aforementioned operations of the compression method. The compression unit has the same advantages as the further developments of the compression method.

Also described below is a decompression method for the decompression of a compressed document, wherein a structured document was compressed into the compressed document in accordance with one of the aforementioned operations of the compression method. The structured document includes at least one informational unit which is instantiated by a type of a specified structural instruction, the structural instruction includes a first base type and a second base type, the first base type is used to represent at least one character, the type includes a data field, which is represented by the at least one first base type and a structure of the data field is determined by a regular expression. A specified decompression method can decompress the compressed document, in which the following operations are performed:
determination of at least one part of the regular expression in such a way that this respective part may be represented by the second base type
decompression at least partially of the compressed document into at least one section by the specified decompression method, wherein the respective section is obtained on the basis of a specified decompression instruction for the second base type
assignment of the respective section to the respective part of the regular expression.

The decompression method makes use of the advantages of the compression method during the decompression of the compressed document.

For example, in the decompression method, the respective section may be assigned to the at least one informational unit, wherein the respective section is based on the respective part of the regular expression. This enables a reconstructed structured document to be generated.

In addition, the decompression method enables two parts of the regular expression to be determined, the new section obtained by decompression on the basis of the two parts can be divided into two sections in such a way that one of the parts is in each case assigned to each of the sections. This enables an increased rate of compression to be achieved.

In a further development of the decompression method, for each of the parts, a new type is formed on the basis of the base type, instead of the at least one informational unit, a first number of new informational units is formed on the basis of the decompression, wherein this first number corresponds to a second number of parts and the new informational units are instantiated on the basis of the new types corresponding to the respective parts and occupied by the sections corresponding to the parts reconstructed by decompression. Here, the advantage is similar to the description of the corresponding compression method.

An improvement of the legibility of sections can be achieved during the decompression method in that at least one of the sections is assigned a tag identifying the at least one section. This can in particular be achieved in that the tag is formed on the basis of the part of the regular expression on which the respective section is based.

For example, in the decompression method, the structural instruction may be defined by the standard XML, wherein
the at least one informational unit is an XML element or XML attribute,
the structured document is an XML document,
the base types are formed from a quantity of XML type built-in primitive types and built-in derived types.

This means the decompression method can be also be used with one of the most common standards, XML.

In addition, the decompression method can be further developed in such a way that, before the decompression operation, it is decided with reference to the at least one part of the regular expression whether the section corresponding to the at least one part is obtained on the basis of the respective specified decompression instruction for the first base type or for the second base type. This variant permits a simple implementation of the decompression method since the structural instruction cannot be changed.

The decompression method makes use of the advantages of the compression method during the decompression of the compressed document. Here, it should be noted that, depending on an implementation, the assignment of a section obtained by decompression to the respective informational unit represents a further development, since the section can be adopted directly by a further processing unit, for example to represent information on a screen.

A further advantage of the decompression method is the fact that the specified decompression method may be used for the decompression of the compressed document since the compression of the sections was performed exclusively on specified base types of the structural instruction using the specified compression method. In addition, the specified decompression method can be performed on the basis of the structural instruction and/or the parts of the regular expression, wherein this enables an adaptation of the specified decompression instruction to the specific circumstances of the structural instruction and/or the parts of the regular expression to be taken into account.

The decompression unit for the decompression of a compressed document, wherein a structured document was compressed into the compressed document with the aid of the compression unit described above. The structured document includes at least one informational unit which is instantiated by a type of a specified structural instruction, the structural instruction includes a first base type and a second base type, the first base type is used to represent at least one character, the type includes a data field, which is represented by the at least one first base type and a structure of the data field is determined by a regular expression. The compressed document can be decompressed by a specified decompression method, in which the decompression unit includes the following units:
a first unit for the determination of at least one part of the regular expression in such a way that this respective can be represented by the second base type
a fifth unit for the decompression of the compressed document into at least one section by the specified decompression method, wherein the respective section can be decompressed on the basis of a specified decompression instruction for the second base type and for assigning the respective section to the respective part of the regular expression.

The decompression unit has the same advantages as the decompression method.

The compression unit further includes a sixth unit embodied in such a way that at least one of the operations may be executed in accordance with the decompression method. The decompression unit has the same advantages as the further developments of the decompression method.

Finally, a compressed document can be generated in accordance with one of the operations of the compression method. The compressed document, for example in the form of a binary file or a data stream, has a higher compression rate than known compression methods. A further advantage of the compressed document is justified by the fact that the specified decompression method can be used for the decompression of the compressed document since the compression of the sections was executed based exclusively on specified base types of the structural instruction using the specified compression method. This achieves a cost-effective implementation.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1A is a character string representing an XML element based on the SVG language;

FIG. 1B is a solid triangle representing the body disclosed by the textual path of the XML element in FIG. 1A;

FIG. 2 is a bar graph of the compression rates comparing the EXI compression method with those of the compression method described below;

FIG. 3 is a block diagram of a compression unit for performing the compression method; and

FIG. 4 is a block diagram of a system including the compression unit, a decompression unit for performing a decompression method and a memory unit for storing a compressed document.

### DETAILED DESCRIPTION OF THE PREFERRED EMBODIMENT

Reference will now be made in detail to the preferred embodiments of the present invention, examples of which are illustrated in the accompanying drawings, wherein elements with same functions and modes of operation have been given the same reference characters.

Following is a first exemplary embodiment. A date can be defined with the aid of a regular expression RA (meeting the definition of a “Regular expression” on the wikipedia website as of Mar. 26, 2009 which is incorporated by reference herein) as follows:

TABLE 1
Date defined as a regular expression
[0-9] {2,2} [.] [0-9] {2,2} [.] [0-9] {4,4}

Hence, a character string for a date generated from the above regular expression reads as follows for example “23.03.2009”.

A structured document DOC (as described, for example, in “The Specification and Validation Framework” of the Structured Document Definition Language in the Jan. 4, 2006 release 0.7.9 of sdvalidator from sourceforge.net which is incorporated by reference herein) includes one or more informational units ELE, ATT. Extensible Markup Language (XML), as standardized by the World Wide Web Consortium or W3C (a description of XML as found on the W3C website on Mar. 31, 2009 is incorporated by reference herein), is one of the most well-known agents for the definition of structured documents. In XML, informational units are formed from elements and attributes. The structure of the structured document is specified by a structural instruction SYN, which, in addition to the syntax, also defines types (TYP). In XML, the structural instruction is known, for example, as a schema or DTD (DTD—document type definition). The informational units are generated by instantiation of the types. The structural instruction specifies several base types for different functions. For example, a first base type (BTSTR) is provided to accept or represent one or more characters. In XML, such base types are described as built-in primitive types and as built-in derived types, wherein the first base type is defined in XML as a “string”. In addition, a second base type BTINT can be specified for the acceptance of whole non-negative numbers, in XML this is for example the base type “nonNegativelnteger”.

For example, the date can be expressed in XML as type TYP=typeDate in the form of a character string as

TABLE 2
Type typeDate defined in XML by the first base type string
<simpleType name=“typeDate” base=“string”/>

In addition, a document definition of the date types can be generated as

TABLE 3
Document definition in XML for date
<element name=“date” type=“typeDate”/>

In the structured document DOC in accordance with XML, the date is encoded as

TABLE 4
Segment of a structured document in XML with date

...
<date>23.03.2009</date>
...

The description of the date in accordance with Table 1 is used to determine the structure of data field DF, that is the structure of the value encoded as a string in accordance with Table 2. The structured document in accordance with Table 4 shows a specific example for the character string date defined by the regular expression. A specified compression method CM for structured documents, such as for example a standard BIM (BIM—binary MPEG format for XML) of the MPEG Organization (MPEG—Motion Picture Expert Group) or EXI (Efficient XML Interchange) of W3C, generates a compressed document BDOC.

First, at least a first part ETA of the regular expression RA is determined in such a way that this first part can be represented by the second base type BTINT. In the regular expression, at the start, two positions each with a number between 0 and 9 are determined ([0-9]{2,2}). This produces a number between 0 and 99. If it were known that this number represents the day of a date, the number could be restricted to a value range between 1 and 31. The second base type “nonNegativelnteger” permits a representation of non-negative numbers of 0, 1 etc. Hence, the first part is ETA=[0-9]{2,2}. On further analysis of the regular expression, it becomes clear that two further parts of the regular expression can be represented as numbers, and, to be precise, [0-9]{2,2} and [0-9]{4,4}. It is also evident that a “colon” character appears in each case between the parts of the regular expression identifiable as numbers.

Using the knowledge that the type typeDate has the aforementioned structure, on the basis of a specified compression instruction CMBTINT for the second base type BTINT, the specified compression method CM can compress at least partially the date instead as a string in several sections. To this end, the informational unit from the structured document, that is the XML element date, is analyzed according to the parts determined above which finds the sections EAS, EAT, EAU corresponding to the parts. The first part ETA=[0-9]{2,2} corresponds to the first section EAS=23. The following table shows the corresponding parts and sections, and underlying base types for each section:

TABLE 5
Assignment of part to section and to base type

| Section | Part | Base type |
|---|---|---|
| 23 | [0-9]{2,2} | BTINT |
| . | [.] | BTSTR |
| 03 | [0-9]{2,2} | BTINT |
| . | [.] | BTSTR |
| 2009 | [0-9]{4,4} | BTINT |

The first exemplary embodiment shows a character string for the date that, in accordance with the definition by the regular expression, does not permit any interpretation of the content.

In a second exemplary embodiment, the regular expression also includes additional information that can be taken into account during the compression. Table 6

TABLE 6
Date defined as expanded regular expression

{day}[0-9]{2,2}[.]{month}[0-9]{2,2}[.]{year}[0-9]{4,4}

also shows in the additional {} brackets explanations of the individual fields of the regular expression. Hence, as an intermediate operation before the compression during the determination of the parts of the regular expression, it is possible to define an individual type for each part, such as for example

TABLE 7
New types for the date in accordance with the expanded regular expression

```
        <simpleType name=“typeDay”
        base=“nonNegativeInteger “/> <simpleType
name=“typeMonth” base=“nonNegativeInteger “/> <simpleType
name=“typeYear” base=“nonNegativeInteger “/>
```

It is also possible to generate a document definition with the new types as

TABLE 8
Document definition in XML for the date in accordance
with the expanded regular expression

<element name=“day” type=“typeDay”/>
<element name=“month” type=“typeMonth”/>
<element name=“year” type=“typeYear”/>

In this document definition, the informational units to be instantiated are also given a respective name day, month, year as a tag. This respective tag may be taken from the expanded regular expression in accordance with Table 6.

The following table shows the corresponding parts 25 ETA, ETB, ETC and sections EAS, EAT, EAU, and the underlying base types and new types for each section:

TABLE 9
Assignment of part to section and to base type

| Section | Part | Base type/new type |
|---|---|---|
| EAS=23 | ETA=[0-9]{2,2} | BTINT = typeDay |
| . | [.] | BTSTR |
| EAT=03 | ETB=[0-9]{2,2} | BTINT = typeMonth |
| . | [.] | BTSTR |
| EAU=2009 | ETC=[0-9]{4,4} | BTINT = typeYear |

This additional configuration has the advantage that a content meaning can be assigned to each section and to each part of the regular expression. For example, instead of the XML type “nonNegativelnteger”, it is also possible to assign the XML type “Positivelnteger” to the new types, since, due to the assignment of the content meaning, it is known that a value for the day, the month and the year is greater than zero. The XML type “Positivelnteger” can achieve a higher compression rate than the XML type “nonNegativelnteger”.

In an additional configuration, the informational unit <date>23.03.2009</date>of the structured document can be changed as follows before the compression into three informational units in accordance with a number of new types formed, see Table 8:

TABLE 10
Changed structured document

<day>23</day>
.
<month>03</month>
.
<year>2009</year>

In a further development, the compression of the two points contained in the regular expression RA can be dispensed with, since due to the sequence of element names day, month and year in conjunction with the associated regular expression in each case, the location of the two points is known.

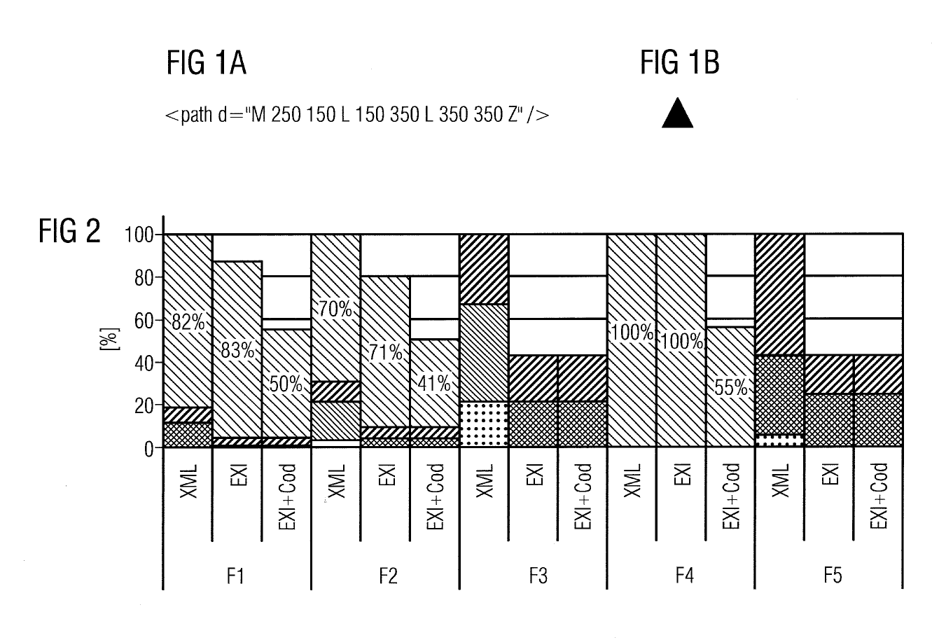

A further exemplary embodiment is explained in more detail with reference to Scalable Vector Graphics (SVG), a standard defined by the organization W3C in as described in the SVG 1.1 Specification dated Jan. 14, 2003 which is incorporated by reference herein). SVC describes two-dimensional vector graphics. The specification defines the structure and functions of SVG using XML. Here, 14 important functions, such as basic shapes, text and color are defined. One very important function are paths. Inside a path, straight or bent lines of a body to be described are defined, the body can, for example, also be filled. The path generated by the XML attribute d initializes the shape of the body based on a coordinate pair (x, y) with the aid of an identifier M, defines with the aid of an identifier L subsequent coordinate pairs (x, y) of the shape and finally, with the aid of the identifier Z, the path is completed. FIG. 1A is a textual description of an SVG path of this kind, FIG. 1B is an illustration of the body disclosed by the textual path.

The following shows which compression rates are achievable with a known method and with the method described herein for the compression of the structured document. The following two compression algorithms are used:

| Name | Explanation |
|---|---|
| XML | This corresponds to the structured document in |
| | non-compressed form (reference value) |
| EXI | a compression method made available by EXI |
| EXI + COD | this compression method uses as a specified |
| | compression method the EXI compression method |
| | and the method described herein. |

Five XML structured documents Fl, . . . , F5 are compressed with the aid of the aforementioned two compression methods. FIG. 2 shows the compression rate relative to the non-compressed XML-structured document=100%. For the document F1, the original size is 100%, the size after the performance of the compression with the aid of the EXI compression method is about 87% and the size of the compressed structured document with the aid of the compression method EXI+COD is about 57%. Hence, the use of the method described herein achieves a significant data reduction in the performance of the compression of the structured document.

Furthermore, in FIG. 2 a portion of the path d as a percentage of the file size of the respective non-compressed or compressed document is entered in the respective layered column. In the original non-compressed structured document F1, the path includes a data content of 82%, in the compressed document in accordance with EXI compression method 83% and when the compression method EXI+COD is used 50%. Hence, it is evident that the use of the method described herein can achieve a significant data reduction with respect to the path information. These observations are similarly applicable to the structured documents F2, F4. In the case of documents F3 and F5, there is no difference between the sizes of the compressed document according to the EXI compression method and the EXI+COD compression method, since, in this exemplary embodiment, the compression method described herein was only applied to paths. However, the aforementioned two structured documents do not contain any path information so that the method described herein cannot achieve any improvement when applied to the path information. However, it is still possible to achieve an improvement if the method described herein is applied to other structural elements of the structured document, in this example in accordance with the SVG standard.

In a further development of the compression method, two parts ETA, ETB of the regular section RA are identified. Here, ETA=[0-9]{2,2} and ETB=[0-9]{2,2}. In addition, two sections EAS, EAT of the informational unit ELE, ATT are determined, wherein these two sections are based on the respective part ETA and ETB, that is EAS=23 and EAT=03. The two sections are combined to form a new section EAN, that is EAN=2303. The new section EAN is then compressed instead of the previous sections EAS, EAT on the basis of the specified compression instruction CMBTINT of the second base type BTINT. With this additional configuration, it should be taken into account that the combination of the sections EAS, EAT to form the new section EAN results in the formation of a section that can also be represented by the second base type and compressed with the associated specified compression instruction CMBTINT. This can take place by an analysis of the two parts ETA, ETB and the instruction for the combination of the two sections, since the instruction for combination can also be applied to the two parts. This results in a new part for [0-9]{2,2}[0-9]{2,2}. Here, a number from 0 to 9999 can be described by the new part. Hence, in this case, the second base type can be used to represent the new part and later the specified compression instruction used.

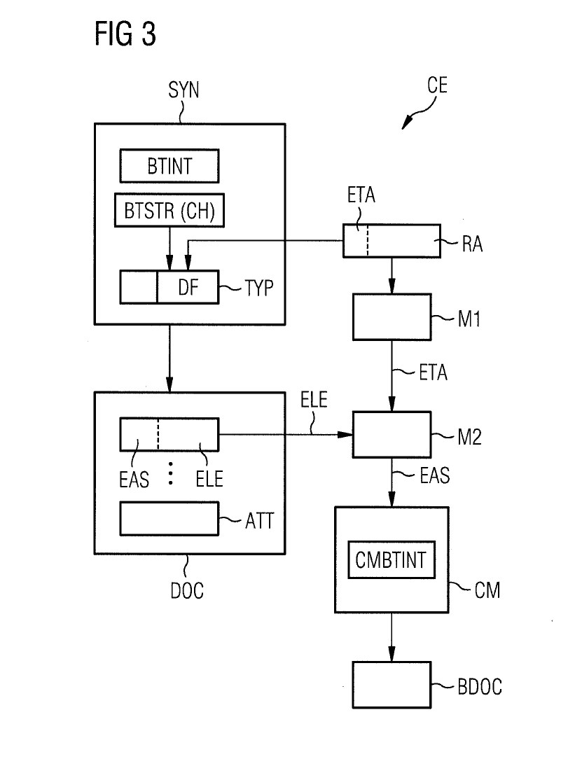

FIG. 3 shows a compression unit CE for the compression of the structured document DOC. The compression unit includes the specified structural instruction SYN, which includes the first base type BTSTR for representing at least the one character CH and the second base type BTINT. In addition, the structural instruction defines the type TYP, which includes a data field, which is represented by at least one first base type and the structure of the data field is determined by the regular expression RA. The dependencies of the types TYP of the first base type BTSTR and its dependence on the regular expression RA are both represented symbolically by an arrow in FIG. 3.

In addition, FIG. 3 shows the structured document with at least the one informational unit ELE, ATT, which is instantiated by the types. The instantiation is symbolized by an arrow on the structured document DOC.

First, a first unit M1 determines at least one part ETA of the regular expression RA in such a way that this respective part ETA can be represented by the second base type BTINT. To this end, the first unit M1 reads-in the regular expression RA at least partially and then, after performing this p\operation, forwards at least the part ETA to a second unit M2.

The second unit M2 is then embodied in a second operation in such a way that it determines the respective section EAS of the at least one informational unit ELE, ATT, which is based on the respective part ETA of the regular expression RA. To this end, the at least one part ETA and the informational unit are at least partially read-in and processed by the second unit and, at one of its outputs, the respective section EAS determined transferred to the specified compression method CM. The specified compression method CM is embodied in such a way that it can compress structured documents formed on the basis of the specified structural instruction SYN. To this end, the specified compression method includes, for example for the second base type BTINT, a specifiable compression instruction CMBTINT. On the basis of this specified compression instruction, the section EAS of the at least one informational unit ELE is compressed. Compression means a reduction of the memory volume required to store the respective section EAS. At the output of the compression unit CE, the structured document DOC is output in compressed form as a compressed document BDOC. The specified compression method CM is based, for example, on BIM or EXI. The compression of the respective section using the specified compression method CM is performed by a third unit M3. It should also be noted that one or more further operations in accordance with the aforementioned exemplary embodiments can be performed with the aid of a fourth unit M4.

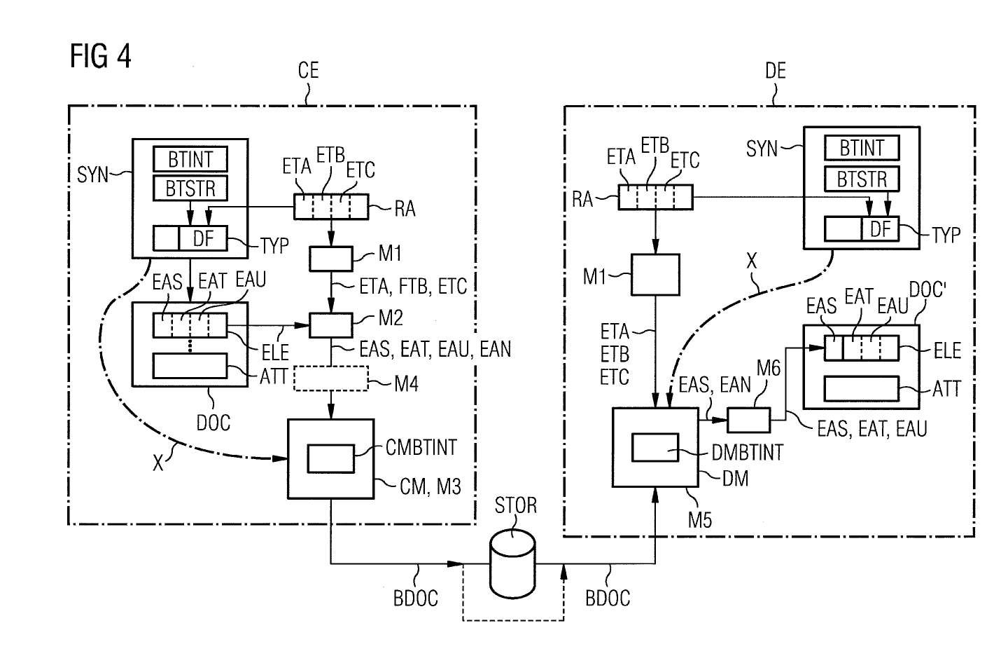

With reference to FIG. 4, the following describes a decompression method for the decompression of the compressed document BDOC into a structured document DOC and the associated decompression unit DE in more detail. The decompression unit includes the specified structural instruction SYN, which includes the first base type BTSTR to represent at least the one character CH and the second base type BTINT. In addition, the structural instruction defines the type TYP, which includes a data field that is represented by at least one first base type and the structure of the data field is determined by the regular expression RA. The dependencies of the types TYP on the first base type BTSTR and its dependence on the regular expression RA are each represented symbolically by an arrow in FIG. 3. The first unit makes available the at least one part ETA of the regular expression RA. During the decompression method or by a fifth unit M5, the at least one part ETA and the compressed document are at least partially read-in.

The fifth unit is embodied in such a way that it can decompress at least one part of the compressed document BDOC into the at least one section EAS. To this end, a specified decompression method DM is used which can decompress the compressed document generated with the specified compression method CM corresponding thereto. The specified decompression method DM is based, for example, on the BIM or EXI standard. Here, it should be noted that, at least for the second base type BTINT, the specified decompression method includes an associated specified decompression instruction DMBTINT with the aid of which a section EAS compressed with the specified compression instruction CMBTINT corresponding thereto can be decompressed. At the output of the fifth unit M5, the at least one section EAS is transferred to a sixth unit M6. The sixth unit can take over the following two tasks:
i) the sixth unit M6 enters the section EAS obtained by decompression at the position in the reconstructed structured document DOC′, which is specified by the part of the regular section corresponding to the section EAS obtained by decompression; and
ii) in one alternative or supplement, the sixth unit M6 can transfer the section EAS to a further processing unit (not shown), wherein during the transfer for example the identifier is also supplied showing which part of the regular expression the transferred section EAS entails. The identifier can be determined as in one of the exemplary embodiments described above.

In addition, the fifth unit can decide before the performance of the decompression with the aid of the at least one part of the regular expression whether the respective specified decompression instruction DMBTSTR, DMBTINT for the first base type BTSTR or the second BTINT will be used to obtain the section corresponding to the at least one part. Each base type has its own specified compression instruction and the corresponding decompression instruction. Therefore, the method can be performed with this additional configuration without any change to the structural instruction since, in the case of the existence of an informational unit, which is at least partially instantiated by the first base type, it is recognized that, to obtain the respective sections by decompression, a base type to be used can be determined on the basis of the regular expression.

In an alternative or supplement to this, the structural instruction SYN can be at least partially changed on the basis of the changes to the informational unit for example into new informational units, wherein this changed structural instruction can be transferred from the compression unit to the decompression unit or the changed structural instruction can be generated similarly in the compression unit and in the decompression unit.

In one additional configuration, at least two parts of the regular expression are taken into account during the compression and decompression. Shown by way of example is the method taking into account three parts, wherein in practice at least two parts are taken into account. The first unit, both on the part of the compression method and decompression method or within the framework of the compression unit or decompression unit, determines the parts ETA, ETB, ETC. The parts ETA, ETB, ETC are generated in such a way that the parts EAS, EAT, EAU of the informational unit corresponding thereto can be compressed in a subsequent compression operation in combined form by the second base type. For example, the parts ETA, ETB, ETC exclusively describe numbers so that, lining up the corresponding sections EAS, EAT, EAU together results in a longer numerical chain, which, in the present example, can be compressed by the second base type. Next, the second unit obtains the sections EAS, EAT, EAUc corresponding to the parts ETA, ETB, ETC. In addition, the second unit combines the sections to form a new section EAN. In the present example, this is performed by stringing together the sections EAS, EAT, EAU. This is followed by the compression of the new section EAN by the third unit.

On the side of the decompression method or the decompression unit, the fifth unit obtains the new section EAN from the compressed document BDOC. The fifth unit sends the new section EAN to the sixth unit M6, which first divides the new section into the sections corresponding to the new section, i.e. into the sections EAS, EAT and EAU. This can be transferred in accordance with the above description into the reconstructed structured document DOC′ or to a processing unit.

FIG. 4 shows the compression unit CE and the decompression unit DE in form of a system by way of example. Here, at the output of the compression unit CE, the compressed document BDOC is transferred to a memory unit STOR. The memory unit is, for example, a server for the intermediate storage of compressed documents. On the request of decompression unit DE, the compressed document BDOC can be transferred to the decompression unit for further processing. Alternatively to this, the direct transfer of the compressed document BDOC from the compression unit to the decompression unit, see dashed arrow in FIG. 4, is possible. Here, the transfer can take place over a network, such as for example GSM (GSM—Global System for Mobile) or over the Internet, for example by LAN and IP/TCP (LAN—Local Area Network, IP—Internet Protocol, TCP—Transport Control Protocol).

The compression unit and the decompression unit can be implemented in hardware, software or in a mixture of hardware and software. For example, individual operations are provided in a program code and executed by a microcontroller. Hereby, individual intermediate operations can be temporarily stored in a memory coupled to the microcontroller. In addition to information for describing the specified structural instruction SYN, this memory can also store the structured document and at least partially the compressed document.

The compression unit CE can be part of an end device, such as for example a video-on-demand server for the provision of multimedia content. The decompression unit can also be part of an end device, such as, for example a navigation system.

The invention was explained with reference to exemplary embodiments. It should be noted that the invention is not restricted to these exemplary embodiments. Reference is also made to the fact that the individual further developments and alternatives of the exemplary embodiments can be combined and that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. A method of compressing a structured document specified by a structural instruction, the structured document including at least one informational unit instantiated by types of the structural instruction, the structural instruction including a first base type and a second base type, the first base type representing at least one character, the types including a data field represented by the first base type, a structure of the data field being determined by a regular expression, comprising:
determining at least one part of the regular expression capable of being represented by the second base type;
determining a corresponding section in each informational unit for each part of the regular expression determined to be represented by the second base type; and
compressing the corresponding section using a specified compression method to compress the corresponding section in accordance with a specified compression instruction for the second base type.

21. The method as claimed in claim 20,
wherein two parts of the regular expression and two sections of each informational unit are determined,
wherein said method further comprises:
combining the two sections of each informational unit to form a new section; and
compressing the new section by the specified compression method in accordance with the specified compression instruction for the second base type.

22. The method as claimed in claim 20, further comprising:
forming, for the parts of the regular expression, respective new second types based on the second base type; and
replacing, prior to said compressing, each informational unit with a first number of new informational units, the first number corresponding to a second number of the parts of the regular expression, with the new informational units instantiated based on the new second types.

23. The method as claimed in claim 20, further comprising attaching, prior to said compressing, a tag to at least one section identifying the at least one section to be compressed.

24. The method as claimed in claim 23, further comprising forming the tag based on the at least one part of the regular expression on which the at least one section is based.

25. The method as claimed in claim 20, wherein the structural instruction is defined using extensible markup language, each informational unit is an extensible markup language element or extensible markup language attribute, the structured document is an extensible markup language document, and the first and second base types are formed from extensible markup language built-in primitive types and built-in derived types.

26. A compression unit for compression of a structured document specified by a structural instruction, the structured document including at least one informational unit instantiated by types of the structural instruction, the structural instruction including a first base type and a second base type, the first base type representing at least one character, the types including a data field represented by the first base type, a structure of the data field being determined by a regular expression, comprising:
a first unit determining at least one part of the regular expression capable of being represented by the second base type;
a second unit determining a corresponding section in each informational unit for each part of the regular expression determined to be represented by the second base type; and
a third unit compressing the corresponding section using a specified compression method to compress the corresponding section in accordance with a specified compression instruction for the second base type.

27. The compression unit as claimed in claim 26,
wherein said first unit determines two parts of the regular expression,
wherein said second unit determines two sections of each informational unit, and
wherein said compression unit further comprises:
a fourth unit combining the two sections of each informational unit to form a new section; and
a fifth unit compressing the new section by the specified compression method in accordance with the specified compression instruction for the second base type.

28. A method for decompression of a compressed document, formed from a structured document specified by a structural instruction, using a specified decompression method, the structured document including at least one informational unit instantiated by types of the structural instruction, the structural instruction including a first base type and a second base type, the first base type representing at least one character, the types including a data field represented by the first base type, a structure of the data field being determined by a regular expression, comprising:
determining at least one part of the regular expression capable of being represented by the second base type;
decompressing at least partially, by the specified decompression method, at least one section from the compressed document, the at least one section being obtained by a specified decompression instruction for the second base type; and
assigning the at least one section to the at least one part of the regular expression.

29. The method as claimed in claim 28, wherein the at least one section is in the at least one informational unit and corresponds to the at least one part of the regular expression.

30. The method as claimed in claim 28,
wherein said determining determines two parts of the regular expression,
wherein said decompressing produces a new section, and
wherein said method further comprises dividing the new section into two sections based on the two parts of the regular expression with each of the parts assigned to one of the sections.

31. The method as claimed in claim 28,
further comprising forming, for parts of the regular expression, respective new second types based on the second base type, and
wherein said decompressing produces a first number of new informational units in the at least one section of the compressed document, the first number corresponding to a second number of the parts of the regular expression, with the new informational units instantiated based on the new second types.

32. The method as claimed in claim 28, wherein a tag identifying at least one section is assigned to the at least one section.

33. The method as claimed in claim 32, wherein the tag is formed based on the at least one part of the regular expression on which the at least one section is based.

34. The method as claimed in claim 28, wherein the structural instruction is defined using extensible markup language, each informational unit is an extensible markup language element or extensible markup language attribute, the structured document is an extensible markup language document, and the first and second base types are formed from extensible markup language built-in primitive types and built-in derived types.

35. The method as claimed in claim 28, further comprising, deciding, prior to said decompressing based on the at least one part of the regular expression, whether the at least one section is obtained based on the specified decompression instruction for the first base type or the second base type.

36. A decompression unit for decompression of a compressed document, formed from a structured document specified by a structural instruction, using a specified decompression method, the structured document including at least one informational unit instantiated by types of the structural instruction, the structural instruction including a first base type and a second base type, the first base type representing at least one character, the types including a data field represented by the first base type, a structure of the data field being determined by a regular expression, comprising:
a first unit determining at least one part of the regular expression capable of being represented by the second base type; and
a second unit decompressing at least partially, by the specified decompression method, at least one section from the compressed document, the at least one section being obtained by a specified decompression instruction for the second base type, and assigning the at least one section to the at least one part of the regular expression.

37. The decompression unit as claimed in claim 36,
wherein said first unit determines two parts of the regular expression,
wherein said second unit produces a new section, and
wherein said decompression unit further comprises a sixth unit dividing the new section into two sections based on the two parts of the regular expression with each of the parts assigned to one of the sections.

38. A compressed document generated according to claim 20.
